(19) United States
(12) Patent Application Publication
(10) Pub. No.: US 2022/0101192 A1
(43) Pub. Date: Mar. 31, 2022

(54) DETECTING FRAUDULENT TRANSACTIONS

(71) Applicant: Callsign Ltd., London (GB)

(72) Inventor: Yogesh Kumar Jitendra Patel, London (GB)

(21) Appl. No.: 17/039,683

(22) Filed: Sep. 30, 2020

(51) Int. Cl. G06N 20/00; G06Q 20/40; G06K 9/62; G06N 7/00

(52) U.S. Cl. CPC G06N 20/00; G06Q 20/4016; G06N 7/005; G06K 9/6256; G06K 9/6263; G06K 9/6228

(57) ABSTRACT

Disclosed are systems, methods, and non-transitory computer-readable media for detecting fraudulent transactions. A fraud detection system determines whether transactions are fraudulent based on a machine learning model framework that leverages a combination of transaction data describing a transaction and sequence data describing a sequence of event preceding the transaction. The machine learning model framework includes multiple feature models that each provide an output based on a different set of feature data describing the transaction, as well an events sequence model that provides an output based on the sequence data describing the sequence of event preceding the transaction. The output of these machine learning models is used to generate a cumulative input that is provided into a secondary machine learning model that outputs a probability value indicating a likelihood that the transaction is fraudulent.

### TECHNICAL FIELD

An embodiment of the present subject matter relates generally to transactions and, more specifically, to a machine learning framework for detecting fraudulent transactions.

### BACKGROUND

The percentage of global expenditures lost by global businesses as a direct result of fraud continues to increase each year. Cyber criminals have been increasingly targeting financial institutions to carry out fraudulent transactions, such as by stealing credit cards or compromising point of sale (POS) devices. Similarly, fraudsters use social engineering tactics, phishing and advance malware to intrude customers' online banking credentials. As fraud losses have become increasingly significant, new tools for detecting fraudulent transactions have been developed. These tools, however, do not provide a comprehensive approach to fraud detection and suffer from low detection accuracy and high false positives. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for detecting fraudulent transactions, according to some example embodiments.

FIG. 2 is a block diagram of a fraud detection system, according to some example embodiments.

FIG. 3 is a block diagram showing communications in a system for detecting fraudulent transactions, according to some example embodiments.

FIG. 4 is a block diagram showing communications in a fraud determination component for detecting fraudulent transactions, according to some example embodiments.

FIG. 5 is a flowchart showing a method for detecting fraudulent transactions, according to some example embodiments.

FIG. 6 is a flowchart showing a method for refining machine learning models for detecting fraudulent transactions, according to some example embodiments.

FIG. 7 is a block diagram illustrating components of a machine, according to some example embodiments, able to read instructions from a machine-readable medium (e.g., a machine-readable storage medium) and perform any one or more of the methodologies discussed herein.

FIG. 8 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for detecting fraudulent transactions. A fraud detection system determines whether requested transactions are fraudulent based on a machine learning model framework that leverages a combination of both transaction data describing a transaction and sequence data describing a sequence of event preceding the transaction. The machine learning model framework utilizes multiple machine learning models and layers of machine learning models. For example, the machine learning model framework may include multiple feature models that each provide an output based on a different set of feature data describing the transaction, as well an events sequence model that provides an output based on sequence data describing the sequence of event preceding the transaction. Each of these machine learning models may be of a different type, such as a sequence to sequence model, recurrent neural network (RNN) model, non-Linear classifiers (e.g., Support Vector Machine), sequence learning (e.g., RNN), and the like. The output of each of these machine learning models (e.g., the feature models and the events sequence model) may be used to generate a cumulative input that is provided into a secondary machine learning model that outputs a probability value (“p-value”) indicating a likelihood that the transaction is or is not fraudulent.

The fraud detection system continuously evaluates and fine tunes the machine learning models to increase the accuracy at which fraud is detected. For example, the fraud detection system may receive external feedback data identifying additional features to be considered when evaluating fraud and automatically update/retrain the individual models to consider the new features. To accomplish this, the fraud detection system may identify the appropriate feature data model to evaluate the new feature(s) and retrain the feature data model based on the new feature(s). The fraud detection system may also use external feedback data indicating the accuracy of its output to further fine-tune its performance. For example, external feedback data indicating whether the fraud detection system correctly determined whether a transaction was fraudulent can be used to determine the impact of the individual features used by the fraud detection system.

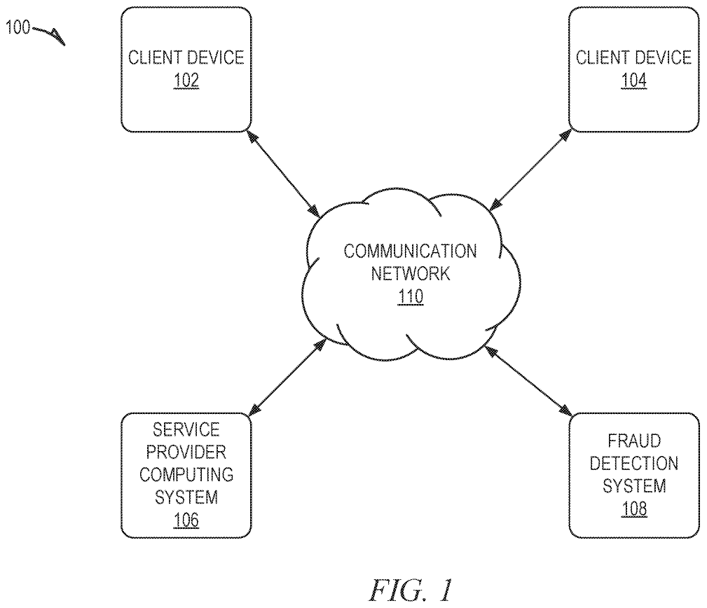

FIG. 1 shows a system 100 for detecting fraudulent transactions, according to some example embodiments. As shown, multiple devices (i.e., client device 102, client device 104, service provider computing system 106, and fraud detection system 108) are connected to a communication network 110 and configured to communicate with each other through use of the communication network 110. The communication network 110 is any type of network, including a local area network (LAN), such as an intranet, a wide area network (WAN), such as the Internet, a telephone and mobile device network, such as cellular network, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

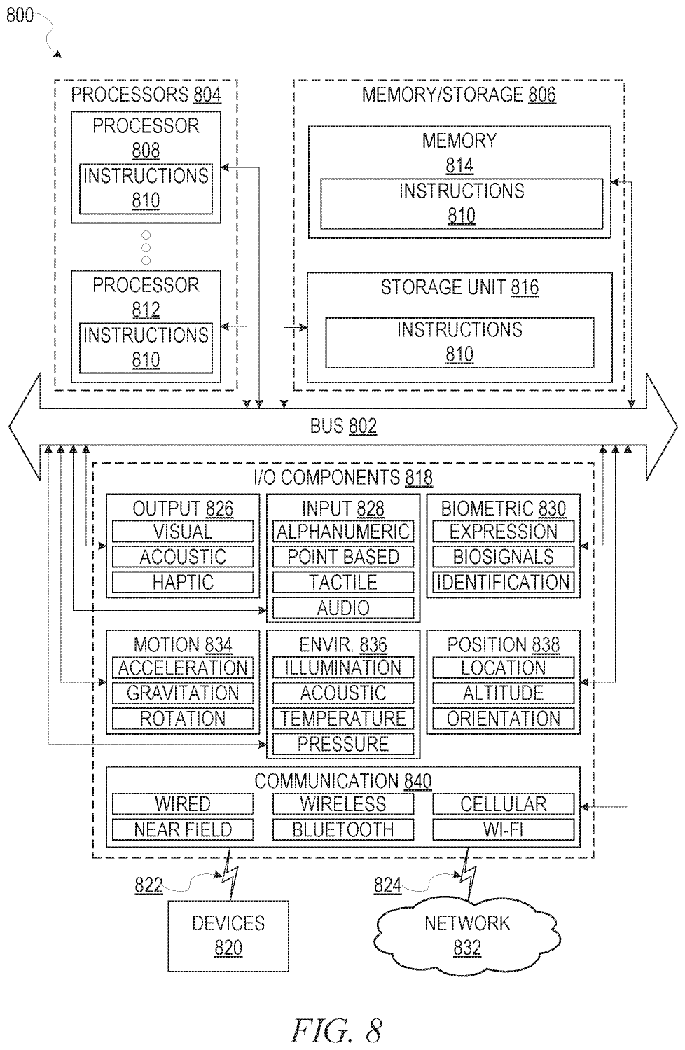

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 800 shown in FIG. 8.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users may interact with a service provider computing system 106 to utilize services provided by a service provide. Users communicate with and utilize the functionality of the service provider computing system 106 by using the client devices 102 and 104 that are connected to the communication network 110 by direct and/or indirect communication. A service provider may provide any type of service, whether it be online or offline, and the service provider computing system 106 may facilitate any related service that is provided online, such as a banking service, online retailer, and the like.

Although the shown system 100 includes only two client devices 102, 104 and one service provider computing system 106, this is only for ease of explanation and is not meant to be limiting. One skilled in the art would appreciate that the system 100 can include any number of client devices 102, 104 and/or service provider computing system 106. Further, each service provider computing system 106 may concurrently accept communications from and initiate communication messages and/or interact with any number of client devices 102, 104, and support connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with a service provider computing system 106 via a client-side application installed on the client devices 102 and 104. In some embodiments, the client-side application includes a component specific to the service provider computing system 106. For example, the component may be a stand-alone application, one or more application plug-ins, and/or a browser extension. However, the users may also interact with the service provider computing system 106 via a third-party application, such as a web browser or messaging application, that resides on the client devices 102 and 104 and is configured to communicate with the service provider computing system 106. In either case, the client-side application presents a user interface (UI) for the user to interact with the service provider computing system 106. For example, the user interacts with the service provider computing system 106 via a client-side application integrated with the file system or via a webpage displayed using a web browser application.

A service provider computing system 106 is one or more computing devices associated with a service provider to provide functionality of the service provider. For example, the service provider computing system 106 may provide an online service. The online service may be any type, such as a banking service, travel service, retail service, etc. The service provider computing system 106, however, does not have to provide an online service that is accessible to users. That is, the service provider computing system 106 may simply be a computing system used by a service provider to perform any type of functionality.

A service provider may enable its users/customers to perform various transactions as part of the services provided by the service provider. A transaction may be any of a variety of types of transaction, such as logging into an account, purchasing items, transferring money, accessing account data, and the like. A service provider may utilize the functionality of the fraud detection system 108 in real time to determine whether a requested transaction is fraudulent. For example, the service provider computing system 106 may transmit a request to the fraud detection system 108 to determine whether a requested transaction is fraudulent. The request may include transaction data describing the requested transaction.

The fraud detection system 108 uses the received transaction data to determine whether the requested transaction is fraudulent. For example, the fraud detection system 108 uses a machine learning model framework that leverages a combination of both the transaction data describing the transaction and sequence data describing a sequence of event preceding the transaction to determine whether the transaction is fraudulent.

As explained earlier, the machine learning model framework utilizes multiple machine learning models and layers of machine learning models. For example, the machine learning model framework includes multiple feature models that each provide an output based on a different set of feature data describing the transaction, as well an events sequence model that provides an output based on the sequence data describing the sequence of event preceding the transaction. The output of each of these machine learning models (e.g., the feature models and the events sequence model) is then used to generate a cumulative input that is provided into a secondary machine learning model that outputs a cumulative probability value indicating a likelihood that the transaction is or is not fraudulent.

The fraud detection system 108 determines whether the transaction is fraudulent based on the resulting cumulative probability value. For example, the fraud detection system 108 compares the cumulative probability value to a threshold probability value and determines the transaction is fraudulent based on whether the cumulative probability value is greater than or less than the threshold probability value. The fraud detection system 108 transmits a response to the service provider computing system 106 indicating whether the requested transaction is fraudulent. The service provider computing system 106 may approve or deny the requested transaction based on the response received from the fraud detection system 108.

The fraud detection system 108 continuously evaluates and fine tunes the machine learning models to increase the accuracy at which it detects fraud. For example, the fraud detection system 108 may receive external feedback data from the service provider computing system 106 that identifies additional features to be considered when evaluating fraud. The fraud detection system 108 may automatically update/retrain the individual models to consider the new features. For example, the fraud detection system 108 may identify the appropriate feature data model to evaluate the new feature(s) and retrain the feature data model based on the new feature(s).

The fraud detection system 108 may also use external feedback data indicating the accuracy of its output to further fine-tune its performance. For example, the service provider computing system 106 may provide the fraud detection system 108 with external feedback data indicating whether the fraud detection system 108 correctly determined whether a transaction was fraudulent. The fraud detection system 108 uses this external feedback data to determine the impact of the individual features used by the fraud detection system 108, as well as to refine the individual models.

Although the fraud detection system 108 and the service provider computing system 106 are shown as separate entities, this is only one embodiment and is not meant to be limiting. In other embodiments, the functionality of the fraud detection system 108 may be partially or completely integrated within the service provider computing system 106.

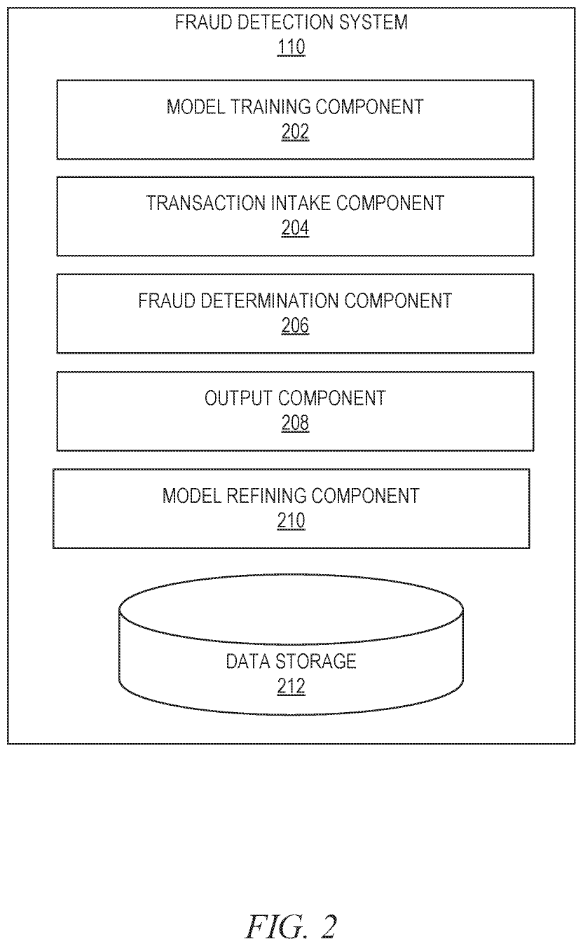

FIG. 2 is a block diagram of a fraud detection system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the fraud detection system 108 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the fraud detection system 108 includes a model training component 202, a request receiving component 204, a fraud determination component 206, an output component 208, a model refining component 210, and a data storage 212.

The model training component 202 trains the individual models in the machine learning model framework, such as the feature models, the events sequence model, and the secondary machine learning model. For example, the model training component 202 gathers training data for each machine learning model and provides the training data to the machine learning algorithms used to generate each machine learning model. The training data is generated from historical transaction data that describes previous transactions executed by service providers. For example, the historical transaction data may include transaction data describing previous transactions such as account logins, fund transfers, and the like. The historical transaction data may be labeled to indicate whether the described transactions were or were not fraudulent.

The model training component 202 extracts the appropriate set of features from the historical transaction data to train each machine learning model. For example, to train a machine learning model that considers the source of a requested transaction, the model training component 202 may extract feature data describing the source, such as the IP address associated with request, the internet browser used, and the like. The model training component 202 may use the extracted features to generated training feature vectors representing the extracted features and whether the transactions were or were not fraudulent. The model training component 202 then provides the training feature vectors to the machine learning algorithm used to generate the machine learning model. Once trained, the resulting machine learning model provides an output probability score indicating the likelihood that a transaction is fraudulent based on the set of features used to train the machine learning model. For example, a machine learning model trained based on features such as the IP address and internet browser used to initiate a request outputs a probability value indicating the likelihood that a requested transaction is fraudulent based on an input feature vector describing the IP address and internet browser used to initiate the requested transaction.

The model training component 202 may access the historical transaction data from the data storage 212 and/or from a service provider computing system 106. For example, the model training component 202 may communicate with the service provider computing system 106 to request the historical transaction data, which may then be stored in the data storage 212. The service provider computing system 106 may also periodically transmit historical transaction data to the fraud detection system 108, which is then stored in the data storage 212. As another example, in embodiments in which the fraud detection system 108 is integrated as part of the service provider computing system 106, transaction data describing requested transactions may be stored directly in the data storage 212.

In some embodiments, the model training component 202 may generate synthetic training data used to train the individual models in the machine learning model framework. For example, the model training component 202 may utilize a generative adversarial network (GAN) machine learning framework to learn how to generate synthetic training data. The network parameters are fine tuned to generate transactional data in sequence. During a training phase, a generator model of the GAN is provided with labeled training data that includes a feature set and attempts to attempts to generate synthetic training data that includes the same feature set. The generated synthetic training data is iteratively reviewed by a discriminator model of the GAN based on the labeled training data, which provides feedback to the generator model indicating how to improve the quality of the synthetic training data. Once the generator model is adequately trained, the model training component 202 may use the generator model to generate synthetic training data, which can be used to train individual models (e.g., the feature models and the events sequence model) in the machine learning framework.

The request receiving component 204 receives requests to determine whether a transaction is fraudulent. The requests may be received from a service provider computing system 106. For example, a service provider utilizing the functionality of the fraud detection system 108 may cause the service provider computing system 106 to transmit requests to the fraud detection system 108 upon receiving transaction requests, such as to purchase items, transfer funds, login to an account, and the like.

A transaction request may be received by the service provider computing system 106 via a client device 102, such as when a user or customer of the service provider is using an online service provided by the service provider computing system 106. Alternatively, the transaction request may be made in-person by a customer, such as a customer requesting to withdraw funds from a bank. In either case, the service provider computing system 106 may subsequently transmit a request to the fraud detection system 108 to determine whether the requested transaction is fraudulent.

The request transmitted to the fraud detection system 108 may include transaction data associated with the requested transaction. For example, the transaction data may include data describing the requested transaction, such as the type of transaction, an amount or quantity associated with the transaction (e.g., monetary amount to transfer, number of items to purchase), a description of an item to purchase, an account being accessed, and the like. The transaction data may also include data describing a client device 102 and or conditions associated with the requested transaction, such as device identifier associated with the client device 102 that requested the transaction, an IP address associated with the client device 102, a country and/or geographic region from which the transaction was requested, a time at which the transaction was requested, and the like. These are just a few examples of transaction data and are not meant to be limiting. The request may include any type of transaction data describing and or related to the requested transaction.

The request receiving component 204 notifies the fraud determination component 206 that a request has been received. The request receiving component 204 may provide the fraud determination component 206 with data related to the request, such as the transaction data received along with the request, a unique identifier for a user and/or account associated with the requested transaction, and the like.

The fraud determination component 206 determines whether a transaction is fraudulent. For example, the fraud determination component 206 uses a machine learning model framework that leverages a combination of both the transaction data describing the transaction and sequence data describing a sequence of event preceding the transaction to determine whether the transaction is fraudulent.

As explained earlier, the machine learning model framework utilizes multiple machine learning models and layers of machine learning models. For example, the machine learning model framework includes multiple feature models that each provide an output based on a different set of feature data describing the requested transaction, as well an events sequence model that provides an output based on the sequence data describing the sequence of event preceding the requested transaction.

The fraud determination component 206 generates inputs for each of the machine learning models (e.g., feature models and events sequence model). For example, the fraud determination component 206 identifies the appropriate feature data used by each feature model from the transaction data describing the requested transaction, The fraud determination component 206 then generates input feature vectors for the various feature models based on the identified feature data. For example, the fraud determination component 206 may use feature data describing the IP address and/or Internet browser associated with a requested transaction to generate an input feature vector. As another example, the fraud determination component 206 may use feature data describing the time at which a transaction was requested and the country in which the request originated to generate an input feature vector for a feature model.

The fraud determination component 206 also generates an input sequence vector to be used as input into the events sequence model. In contrast to the feature models that consider feature data describing the requested transaction, the events sequence model considers the sequence of events preceding the requested transaction. For example, the events sequence model may consider a sequence of events such as the previous transactions performed by the particular user or customer, the locations of the previous transactions, the types of transactions performed by the customer, monetary amounts associated with the transactions, the times at which transactions occurred, and the like. Accordingly, the fraud determination component 206 accesses historical transaction data associated with the user or account to generate the input sequence vector.

The fraud determination component 206 provides the generated inputs (e.g., input feature vectors and input sequence vectors) into their corresponding machine learning models. Each machine learning model provides an output probability value indicating the likelihood that the requested transaction is fraudulent based on its provided input. The fraud determination component 206 uses the output of each of these machine learning models (e.g., the feature models and the events sequence model) to generate a cumulative input vector that is provided as input into a secondary machine learning model that provides a cumulative model output. Accordingly, the secondary machine learning model outputs a cumulative probability value indicating the likelihood that the transaction is or is not fraudulent based on the output of each of the preceding the machine learning models (e.g., the feature models and the events sequence model).

The fraud determination component 206 determines whether the transaction is fraudulent based on the resulting cumulative probability value. For example, the fraud determination component 206 compares the cumulative probability value to a threshold probability value and determines whether the transaction is fraudulent based on the comparison. For example, the fraud determination component 206 may determine that a requested transaction is fraudulent if the cumulative probability value is greater than the threshold probability value.

The fraud determination component 206 provides the output component 208 with data indicating whether the requested transaction was determined to be fraudulent. In turn, the output component 208 communicates the determination to the service provider computing system 106. The service provider computing system 106 may then choose to either approve or deny the requested transaction based on the determination received from the fraud detection system 108. The fraud determination component 206 may also update the data storage 212 based on the resulting output. For example, the fraud determination component 206 may generate and/or update a record associated with the requested transaction to indicate whether the requested transaction was determined to be fraudulent or not fraudulent. The record may also include the transaction data associated with the requested transaction.

The model refining component 210 evaluates and fine tunes the individual machine learning models (e.g., feature models and/or events sequence model) to increase the accuracy at which the fraud detection system 108 detects fraud. For example, the model refining component 210 may receive external feedback data from the service provider computing system 106 that identifies additional features to be considered when evaluating fraud. In turn, the model refining component 210 may automatically update/retrain individual feature models to consider the new features.

As part of this process, the model refining component 210 may initially determine which of the feature models to retrain to evaluate the new feature(s) identified by the external feedback data. This may be accomplished by identifying a feature model that evaluates similar feature data as described by the external feedback data and then retraining the feature model to consider the additional feature data. For example, if the external feedback data indicates that transactions received within certain hours and from a specified geographic region have a high likelihood of being fraudulent, the model refining component 210 may initially identify a feature model that considers either the geographic region and/or time associated with a transaction. The model refining component 210 may then cause the identifier feature model to be retrained based on the new feature(s) identified by the external feedback data.

To update and retrain the identified feature model, the model refining component 210 instructs the fraud determination component 206 to add the new feature data when generating input feature vectors for the identified feature model. The model refining component 210 also instructs the model training component 202 to retrain the feature model based on the modified feature data.

The model refining component 210 may also fine-tune performance of the machine learning models based on external feedback data indicating whether the determinations generated by the fraud detection system 108 were correct. For example, the service provider computing system 106 may provide the fraud detection system 108 with external feedback data indicating whether the fraud detection system 108 correctly determined whether a transaction was fraudulent. The model refining component 210 uses this external feedback data to determine the impact of the individual features used by the various feature models, as well as to refine the individual feature models. For example, the model refining component 210 may use the external feedback data to determine whether a modification to a feature model, such as adding a new feature, resulted in an increase or decrease in the accuracy of the fraud detection system 108. If accuracy decreased after a change was made, the model refining component 210 may refine the feature models to revert to use of the previous feature data.

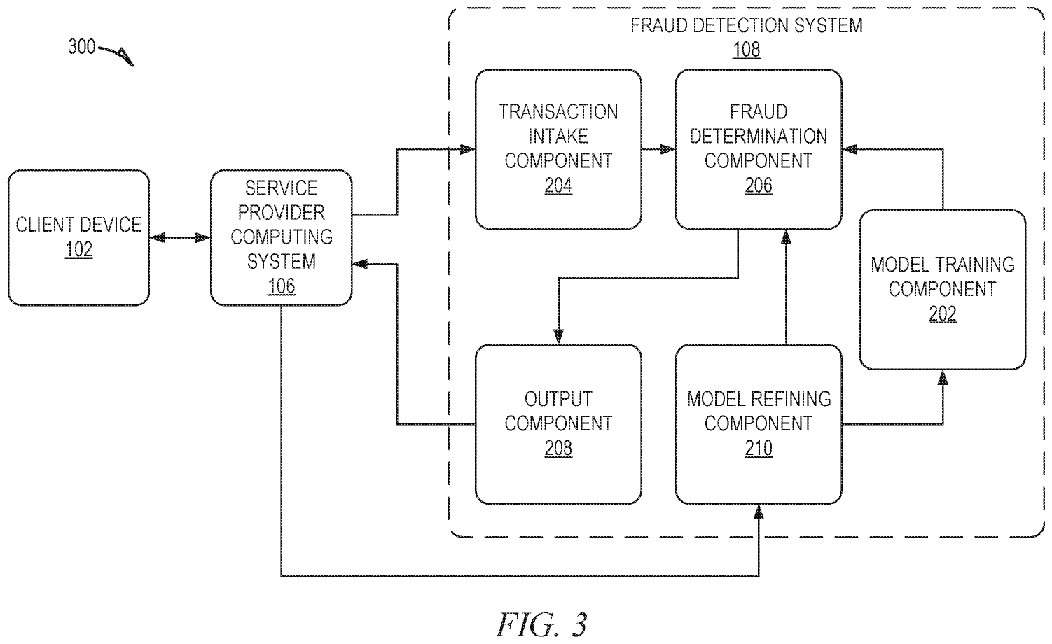

FIG. 3 is a block diagram showing communications in a system 300 for detecting fraudulent transactions, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components/devices may be supported by the system 300 to facilitate additional functionality that is not specifically described herein. Furthermore, the various functional components/devices depicted in FIG. 3 may reside on a single computing device or may be distributed across several computing devices in various arrangements such as those used in cloud-based architectures.

As shown, a service provider computing system 106 communicates with a fraud detection system 108 to determine whether a requested transaction is fraudulent. The requested transaction may be initiated using a client device 102 that communicates with the service provider computing system 106. The service provider computing system 106 transmits a request to the fraud detection system 108 to determine whether a requested transaction is fraudulent.

The request transmitted by the service provider computing system 106 is received by the transaction intake component 204. The request may include transaction data describing the requested transaction. The transaction intake component 204 provides the transaction data to the fraud determination component 206. The fraud determination component 206 uses the transaction data to determine whether the requested transaction is fraudulent. For example, the fraud determination component 206 generates a set of input feature vectors based on the transaction data and provides the input feature vectors as input into a set of feature models. The fraud determination component 206 may also generate an input sequence vector describing a sequence of transactions preceding the requested transaction. The fraud determination component 206 provides the input sequence vector as input into an events sequence model.

Each machine learning model provides an output probability value indicating the likelihood that the requested transaction is fraudulent based on its provided input. The fraud determination component 206 uses the output of each of the machine learning models (e.g., the feature models and the events sequence model) to generate a cumulative input vector that is provided as input into a secondary machine learning model. The secondary machine learning model then outputs a cumulative probability value indicating the likelihood that the transaction is or is not fraudulent based on the output of each of the preceding the machine learning models (e.g., the feature models and the events sequence model).

The fraud determination component 206 determines whether the transaction is fraudulent based on the resulting cumulative probability value. For example, the fraud determination component 206 compares the cumulative probability value to a threshold probability value and determines whether the transaction is fraudulent based on the comparison.

The fraud determination component 206 provides the output component 208 with data indicating whether the requested transaction was determined to be fraudulent. In turn, the output component 208 communicates the determination to the service provider computing system 106. The service provider computing system 106 may then choose to either approve or deny the requested transaction based on the determination received from the fraud detection system 108.

As shown, the service provider computing system 106 provides external feedback data to the fraud detection system 108, which is received by the model refining component 210. The external feedback data may indicate new features or sets of features to be considered for determining whether a transaction is fraudulent. The external feedback data may also include data indicating the accuracy of the determinations provided by the fraud detection system 108.

The model refining component 210 may automatically update/retrain the individual models used to determine whether a transaction is fraudulent based on the external feedback data received from the service provider computing system 106. For example, the model refining component 210 may provide the fraud determination component 206 with instructions to modify the feature data used when generating input feature vectors for one or more of the feature models and/or sequence event model. The instruction may be to add or remove specified features when generating the input vectors. The model refining component 210 also instructs the model training component 202 to retrain the feature model(s) and/or sequence event model based on the modified feature data.

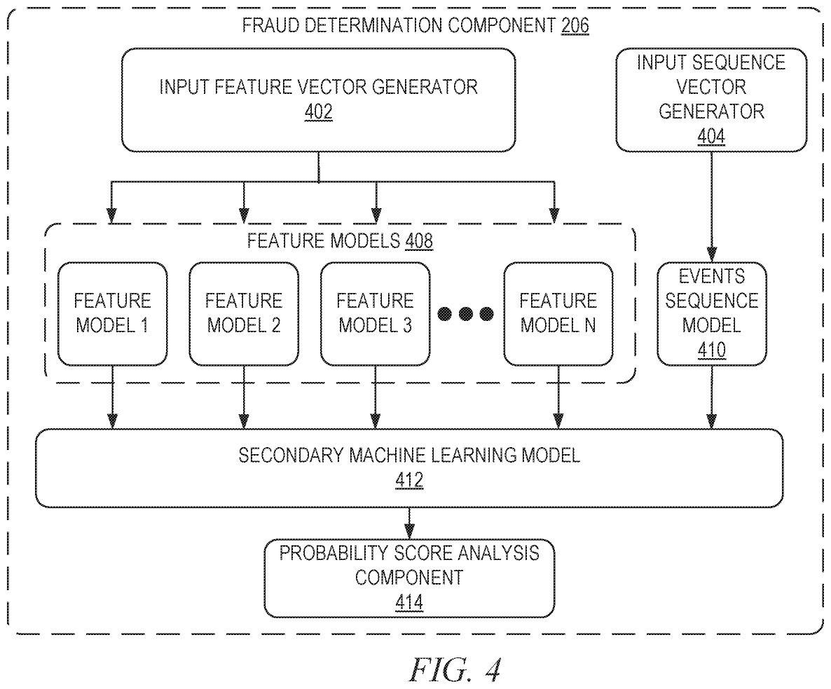

FIG. 4 is a block diagram showing communications in a fraud determination component 206 for detecting fraudulent transactions, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components/devices may be supported by the fraud determination component 206 to facilitate additional functionality that is not specifically described herein. Furthermore, the various functional components/devices depicted in FIG. 4 may reside on a single computing device or may be distributed across several computing devices in various arrangements such as those used in cloud-based architectures

As shown, the fraud determination component 206 includes an input feature vector generator 402, an input sequence vector generator 404, a set of feature models 408, an events sequence model 410, a secondary machine learning model 412, and a probability score analysis component 414.

The input feature vector generator 402 generates input feature vectors for the individual feature models 408. Each feature model 408 is a separate machine learning model that generates a probability score indicating the likelihood that a transaction is fraudulent based on a different set of features describing a transaction. For example, the feature models 408 may include individual models that generate a probability score based on one or more features such as transaction amount, event type, latency, IP address, user agent, transaction time, account number, sort code, and the like.

As shown, the feature models 408 may include any number of individual models. Further, each individual feature model 408 may be a different type of machine learning model. For example, each individual feature model 408 may have been generated using a different machine learning algorithm, such as Linear Regression, Logistic Regression, Decision Tree, Support Vector Machine, Naive Bayes, k-Nearest Neighbor, K-Means, Random Forest, and the like.

The input feature vector generator 402 generates input feature vectors for the individual feature models 408 based on transaction data describing a requested transaction. For example, the transaction data may be provided by a service provider computing system 106. The input feature vector generator 402 analyzes the transaction data and extracts the feature data that is used by each feature model 408 as input. or example, the input feature vector generator 402 may extract feature data such as the IP address to be used as input by one of the feature models 408, feature data describing a transaction amount to be used as input by another one of the feature models 408, and so on.

The input feature vector generator 402 uses the gathered feature data for each of the feature models 408 to generate an input feature vector for each respective feature model 408. Each input feature vector includes a set of values that represent the feature data gathered from the transaction data. For example, an input feature vector representing an event type may include a combination of values representing the event type.

In some embodiments, the input feature vector generator 402 may request additional transaction data from a service provider computing system 106. For example, the input feature vector generator 402 may determine that the transaction data received form the service provider computing system 106 is insufficient for generated input feature vectors used to determine whether the requested transaction is fraudulent. In this type of situation, the input feature vector generator 402 may transmit a request to the service provider computing system 106 for additional transaction data. For example, the request may identify the specific transaction data to be provided by the service provider computing system 106 to the input feature vector generator 402. Alternatively, the request may be a general request for additional transaction data that does no identify the additional transaction data that is needed. Similarly, the input sequence vector generator 404 generates an input sequence vector to be used as input by the events sequence model 410. The events sequence model 410 provides a probability output based on a sequence of events preceding the requested transaction. For example, the events sequence model 410 may consider a sequence of events such as the previous transactions performed by the particular user or customer, the locations of the previous transactions, the types of transactions performed by the customer, monetary amounts associated with the transactions, the times at which transactions occurred, and the like. Accordingly, the input sequence vector generator 404 accesses historical transaction data for the user or account associated with the requested transaction and generates the input sequence vector based on the historical transaction data. As the input sequence vector is generated based on the previous transactions associate with the user or account, the length of the input sequence vectors generated by the input sequence vector generator 404 may be of varying lengths.

The resulting input feature vectors and the input sequence vector are provided as input into their respective feature models 408 and the events sequence model 410. Each provides an output probability value based on its given input. As shown, these output probability values are then used as input into the secondary machine learning model 412. For example, the output probability values from the feature models 408 and the events sequence model 410 may be used to generate a cumulative input, such as a cumulative input vector, that is used as input into the secondary machine learning model 412.

The secondary machine learning model 412. is a deep learning model that uses techniques such as deep neural networks to produce an optimized classification for a requested transaction. For example, the secondary machine learning model 412 may use the Long Short-Term Memory (LSTM) family of Recurrent Neural Network model, SVM model and Markov model as an event sequence learner for detecting fraud. The secondary machine learning model 412 provides a cumulative probability value based on the individual probability values output by the feature models 408 and the events sequence model 410. The cumulative probability value indicates the likelihood that the requested transaction is fraudulent. For example, the cumulative probability value may be a value indicating an estimated percentage of likelihood that the requested transaction is fraudulent or not fraudulent. Further, in some embodiments, the secondary machine learning model 412 may provide two separate probability score outputs, one indicating the estimated percentage of likelihood that the requested transaction is fraudulent and the other indicating the estimated percentage of likelihood that the requested transaction is not fraudulent.

The probability score analysis component 414 determines whether the requested transaction is fraudulent based on the output of the secondary machine learning model 412. For example, the probability score analysis component 414 may determine whether the requested transaction is fraudulent based on whether the cumulative probability score exceeds a threshold probability score. The threshold probability score may indicate a threshold value above which the cumulative probability score indicates that the requested transaction is or is not fraudulent. For example, in embodiments where the cumulative probability score indicates that likelihood that the requested transaction is fraudulent, the probability score analysis component 414 may determine that the requested transaction is fraudulent when the cumulative probability score exceeds the threshold probability score. Alternatively, in embodiments where the cumulative probability score indicates that likelihood that the requested transaction is not fraudulent, the probability score analysis component 414 may determine that the requested transaction is fraudulent when the cumulative probability score is below the threshold probability score.

In some embodiments, the threshold probability score used by the probability score analysis component 414 may be specific to an account associated with a requested transaction. For example, a threshold probability score may be determined for each account based on transaction data and external feedback data associated with the account. Accordingly, the threshold probability scores used to determine whether transactions are fraudulent may be different based on the account associated with a requested transaction.

In this type of embodiment, the fraud detection system 108 may initially use assign a default threshold probability score to each account and then modify the threshold probability score for each account based on transactions associated with the account and/or external feedback data. The fraud detection system 108 may store transaction data for each account as transactions are received by the fraud detection system 108. The probability score analysis component 414 may use this historical transaction data to update the threshold probability score for the account based on the transactions performed by the account. External feedback data indicating whether the probability score analysis component 414 was able to correctly determine whether a transaction was fraudulent can further be used to adjust the threshold probability score for each account as well.

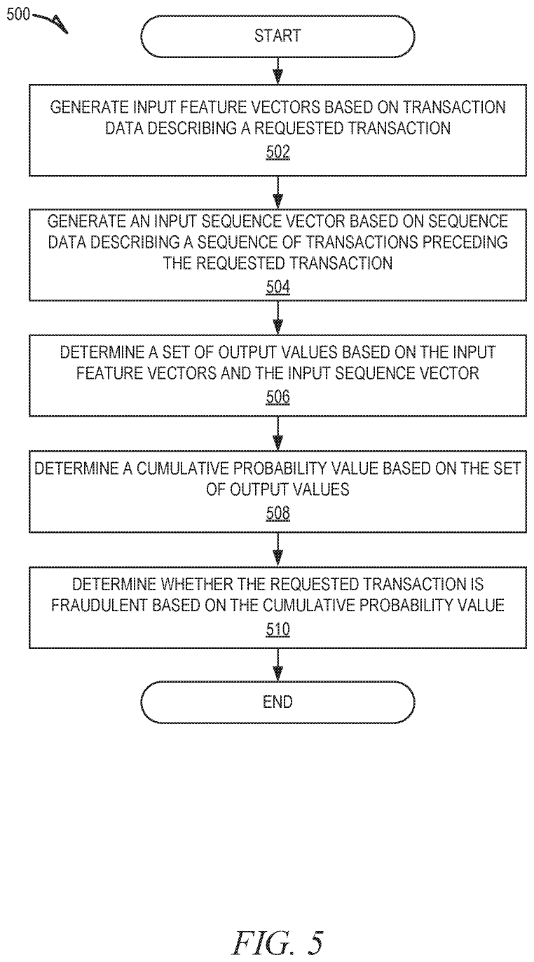

FIG. 5 is a flowchart showing a method 500 for detecting fraudulent transactions, according to some example embodiments. The method 500 may be embodied in computer readable instructions for execution by one or more processors such that the operations of the method 500 may be performed in part or in whole by the fraud detection system 108; accordingly, the method 500 is described below by way of example with reference thereto. However, it shall be appreciated that at least some of the operations of the method 500 may be deployed on various other hardware configurations and the method 500 is not intended to be limited to the fraud detection system 108.

At operation 502, the input feature vector generator 402 generates input feature vectors based on transaction data describing a requested transaction. For example, the transaction data may be provided by a service provider computing system 106. The input feature vector generator 402 analyzes the transaction data and extracts the feature data that is used by each feature model 408 as input. For example, the input feature vector generator 402 may extract feature data such as the IP address to be used as input by one of the feature models 408, feature data describing a transaction amount to be used as input by another one of the feature models 408, and so on.

The input feature vector generator 402 uses the gathered feature data for each of the feature models 408 to generate an input feature vector for each respective feature model 408 Each input feature vector includes a set of values that represent the feature data gathered from the transaction data. For example, an input feature vector representing an event type may include a combination of values representing the event type

At operation 504, the input sequence vector generator 404 generates an input sequence vector based on sequence data describing a sequence of transactions preceding the requested transaction. In some embodiments, operation 504 may be performed in parallel with operation 502. The input sequence vector is to be used as input by the events sequence model 410. The events sequence model 410 provides a probability output based on a sequence of events preceding the requested transaction. For example, the events sequence model 410 may consider a sequence of events such as the previous transactions performed by the particular user or customer, the locations of the previous transactions, the types of transactions performed by the customer, monetary amounts associated with the transactions, the times at which transactions occurred, and the like. Accordingly, the input sequence vector generator 404 accesses historical transaction data for the user or account associated with the requested transaction and generates the input sequence vector based on the historical transaction data.

At operation 506, the feature models 408 and the events sequence model 410 determine a set of output values based on the input feature vectors and the input sequence vector. For example, the input feature vectors, and the input sequence vector are provided as input into their respective feature models 408 and the events sequence model 410. Each feature model 408 and the events sequence model 410 provides an output probability value based on its given input.

At operation 508, the secondary machine learning model 412 determines a cumulative probability value based on the set of output values. For example, the output probability values from the feature models 408 and the events sequence model 410 may be used to generate a cumulative input, such as a cumulative input vector, that is used as input into the secondary machine learning model 412.

The secondary machine learning model 412 is a deep learning model that uses techniques such as deep neural networks to produce an optimized classification for a requested transaction. For example, the secondary machine learning model 412 may use the Long Short-Term Memory (LSTM) family of Recurrent Neural Network model, SVM model and Markov model as an event sequence learner for detecting fraud. The secondary machine learning model 412 provides a cumulative probability value based on the individual probability values output by the feature models 408 and the events sequence model 410. The cumulative probability value indicates the likelihood that the requested transaction is fraudulent. For example, the cumulative probability value may be a value indicating an estimated percentage of likelihood that the requested transaction is fraudulent or not fraudulent.

At operation 510, the probability score analysis component 414 determines whether the requested transaction is fraudulent based on the cumulative probability value. For example, the probability score analysis component 414 may determine whether the requested transaction is fraudulent based on whether the cumulative probability score exceeds a threshold probability score. The threshold probability score may indicate a threshold value above which the cumulative probability score indicates that the requested transaction is or is not fraudulent. For example, in embodiments where the cumulative probability score indicates that likelihood that the requested transaction is fraudulent, the probability score analysis component 414 may determine that the requested transaction is fraudulent when the cumulative probability score exceeds the threshold probability score. Alternatively, in embodiments where the cumulative probability score indicates that likelihood that the requested transaction is not fraudulent, the probability score analysis component 414 may determine that the requested transaction is fraudulent when the cumulative probability score is below the threshold probability score.

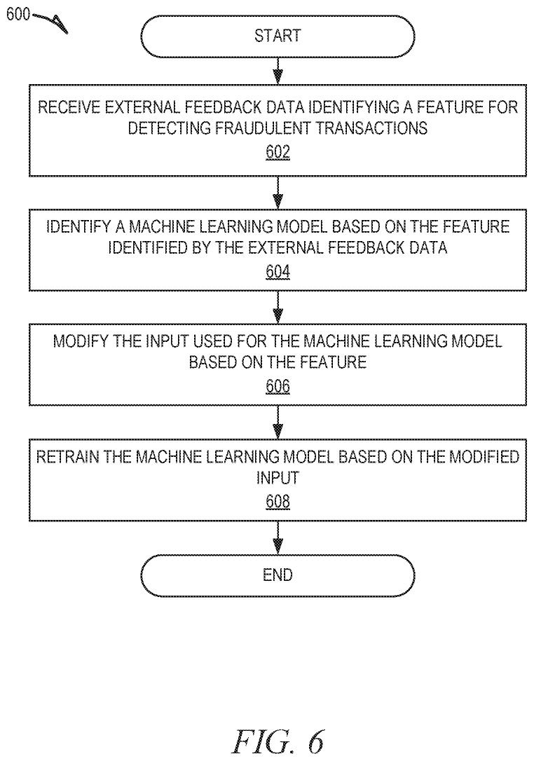

FIG. 6 is a flowchart showing a method 600 for refining machine learning models for detecting fraudulent transactions, according to some example embodiments. The method 600 may be embodied in computer readable instructions for execution by one or more processors such that the operations of the method 600 may be performed in part or in whole by the fraud detection system 108; accordingly, the method 600 is described below by way of example with reference thereto. However, it shall be appreciated that at least some of the operations of the method 600 may be deployed on various other hardware configurations and the method 600 is not intended to be limited to the fraud detection system 108.

At operation 602, the model refining component 210 receives external feedback data identifying a feature for detecting fraudulent transactions. For example, the model refining component 210 may receive external feedback data from the service provider computing system 106 that identities additional features to be considered when evaluating fraudulent transactions.

The model refining component 210 may automatically update/retrain the individual models to consider the new features. As part of this process, at operation 604, the model refining component 210 identifies a machine learning model based on the feature identified by the external feedback data. In some embodiments, the model refining component 210 accomplishes this by identifying a feature model that evaluates similar feature data as described by the external feedback data. For example, if the external feedback indicates that transactions received within certain hours from a specified geographic region have a high likelihood of being fraudulent, the model refining component 210 may identify a feature model that uses input identifying the time of the requested transaction to be modified to further consider the geographic region of the requested transaction.

At operation 606, the model refining component 210 modifies the input used for the machine learning model based on the feature. For example, the model refining component 210 instructs the fraud determination component 206 to add the new feature data when generating input feature vectors for the identified feature model.

At operation 608, the model refining component 210 retrains the machine learning model based on the modified input. For example, the model refining component 210 instructs the model training component 202 to retrain the feature model based on the modified feature data.

### Software Architecture

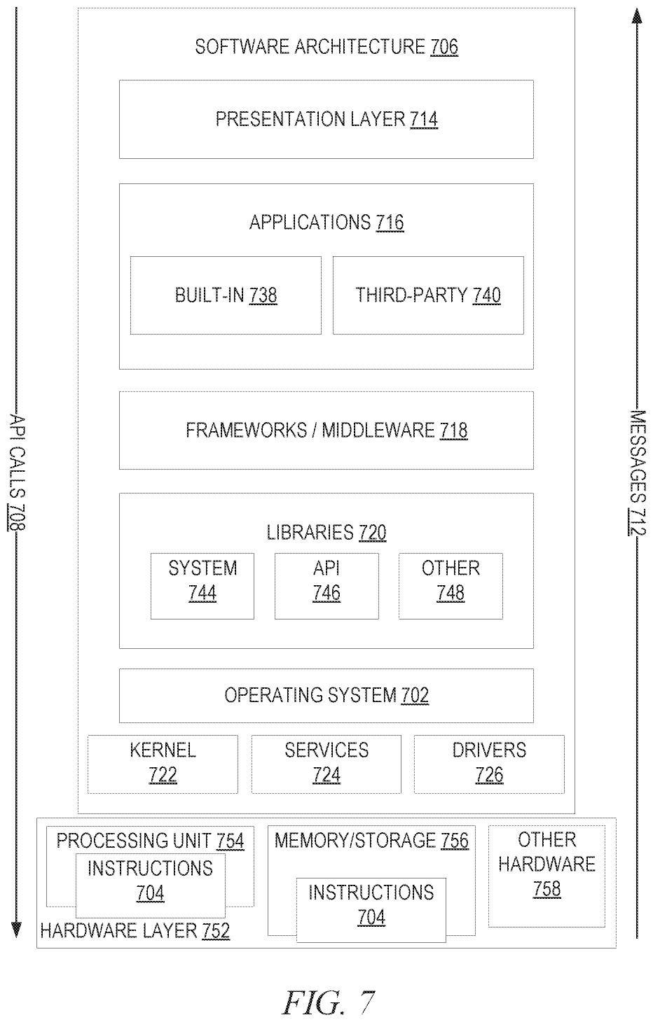

FIG. 7 is a block diagram illustrating an example software architecture 706, which may be used in conjunction with various hardware architectures herein described. FIG. 7 is a non-limiting example of a software architecture 706 and it will be appreciated that many other architectures may be implemented to facilitate the functionality described herein. The software architecture 706 may execute on hardware such as machine 800 of FIG. 8 that includes, among other things, processors 804, memory 814, and (input/output) I/O components 818. A representative hardware layer 752 is illustrated and can represent, for example, the machine 800 of FIG. 8. The representative hardware layer 752 includes a processing unit 754 having associated executable instructions 704. Executable instructions 704 represent the executable instructions of the software architecture 706, including implementation of the methods, components, and so forth described herein. The hardware layer 752 also includes memory and/or storage modules 756, which also have executable instructions 704. The hardware layer 752 may also comprise other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716, and a presentation layer 714. Operationally, the applications 716 and/or other components within the layers may invoke application programming interface (API) calls 708 through the software stack and receive a response such as messages 712 in response to the API calls 708. The layers illustrated are representative in nature and not all software architectures have all layers. For example, some mobile or special purpose operating systems may not provide a frameworks/middleware 718. while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 720 provide a common infrastructure that is used by the applications 716 and/or other components and/or layers. The libraries 720 provide functionality that allows other software components to perform tasks in an easier fashion than to interface directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/modules.

The frameworks/middleware 718 (also sometimes referred to as middleware) provide a higher-level common infrastructure that may be used by the applications 716 and/or other software components/modules. For example, the frameworks/middleware 718 may provide various graphical user interface (GUI) functions, high-level resource management, high-level location services, and so forth. The frameworks/middleware 718 may provide a broad spectrum of other APIs that may be used by the applications 716 and/or other software components/modules, some of which may be specific to a particular operating system 702 or platform.

The applications 716 include built-in applications 738 and/or third-party applications 740. Examples of representative built-in applications 738 may include, but are not limited to, a contacts application, a browser application, a book reader application, a location application, a media application, a messaging application, and/or a game application. Third-party applications 740 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 740 may invoke the API calls 708 provided by the mobile operating system (such as operating system 702) to facilitate functionality described herein.

The applications 716 may use built in operating system functions (e.g., kernel 722, services 724, and/or drivers 726), libraries 720, and frameworks/middleware 718 to create UIs to interact with users of the system. Alternatively, or additionally, in some systems, interactions with a user may occur through a presentation layer, such as presentation layer 714. In these systems, the application/component “logic” can be separated from the aspects of the application/component that interact with a user.

FIG. 8 is a block diagram illustrating components of a machine 800, according to some example embodiments, able to read instructions 704 from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an apples, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 800 capable of executing the instructions 810, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. In various example embodiments, the 110 components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environmental components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environmental components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via coupling 824 and coupling 822, respectively. For example, the communication components 840 may include a network interface component or other suitable device to interface with the network 832. In further examples, communication components 840 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 810 for execution by the machine 800, and includes digital or analog communications signals or other intangible medium to facilitate communication of such instructions 810. Instructions 810 may be transmitted or received over the network 832 using a transmission medium via a network interface device and using any one of a number of well-known transfer protocols.

“CLIENT DEVICE” in this context refers to any machine 800 that interfaces to a communications network 832 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 832.

“COMMUNICATIONS NETWORK” in this context refers to one or more portions of a network 832 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 832 or a portion of a network 832 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 810 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 810. The term “machine-readable medium” shall also be taken to include any medium, or combination of multiple media, that is capable of storing instructions 810 (e.g., code) for execution by a machine 800, such that the instructions 810, when executed by one or more processors 804 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 804) may be configured by software (e.g., an application 716 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 804 or other programmable processor 804. Once configured by such software, hardware components become specific machines 800 (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 804 configured by software to become a special-purpose processor, the general-purpose processor 804 may be configured as respectively different special-purpose processors (e.g., comprising different hardware components) at different times. Software accordingly configures a particular processor or processors 804, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 802) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 804 that are temporarily configured (e.g., by software) or permanently configured to perform the relevant operations. Whether temporarily or permanently configured, such processors 804 may constitute processor-implemented components that operate to perform one or more operations or functions described herein. As used herein, “processor-implemented component” refers to a hardware component implemented using one or more processors 804. Similarly, the methods described herein may be at least partially processor-implemented, with a particular processor or processors 804 being an example of hardware. For example, at least some of the operations of a method may be performed by one or more processors 804 or processor-implemented components. Moreover, the one or more processors 804 may also operate to support performance of the relevant operations in a “cloud computing” environment or as a “software as a service” (SaaS). For example, at least sonic of the operations may be performed by a group of computers (as examples of machines 800 including processors 804), with these operations being accessible via a network 832 (e.g., the Internet) and via one or more appropriate interfaces (e.g., an API). The performance of certain of the operations may be distributed among the processors 804, not only residing within a single machine 800, but deployed across a number of machines 800. In some example embodiments, the processors 804 or processor-implemented components may be located in a single geographic location (e.g., within a home environment, an office environment, or a server farm). In other example embodiments, the processors 804 or processor-implemented components may be distributed across a number of geographic locations.

“PROCESSOR” in this context refers to any circuit or virtual circuit (a physical circuit emulated by logic executing on an actual processor 804) that manipulates data values according to control signals (e.g., “commands,” “op codes,” “machine code,” etc.) and which produces corresponding output signals that are applied to operate a machine 800. A processor 804 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 804 may further be a multi-core processor having two or more independent processors 804 (sometimes referred to as “cores”) that may execute instructions 810 contemporaneously.

### NON-LIMITING EXAMPLES

Example 1 is a method comprising: generating at least a first feature vector and a second feature vector representing a first transaction, the first feature vector being different than the second feature vector; generating a first sequence vector representing a sequence of transactions associated with the first transaction, the sequence of transactions including the first transaction and at least one transaction preceding the first transaction; providing the first feature vector as input into a first machine learning model, resulting in a first feature output value; providing the second feature vector as input into a second machine learning model, resulting in a second feature output value, the second machine learning model being different than the first machine learning model; providing the first sequence vector as input into an events sequence model, resulting in a first sequence output value; providing, a first cumulative input into a secondary machine learning model, resulting in a first cumulative probability value indicating a likelihood that the first transaction is fraudulent, wherein the first cumulative input is generated based on the first feature output value, the second feature output value, and the first sequence output value; and determining whether the first transaction is fraudulent based on a comparison of the first cumulative probability value to a first threshold probability value.

Example 2, the subject matter of Example 1 includes, further comprising: providing a third feature vector representing the first transaction as input into a third machine learning model, resulting in a third feature output value, wherein the first cumulative input is further generated based on the third feature output value.

In Example 3, the subject matter of Examples 1-2 includes, further comprising: generating at least a third feature vector and a fourth feature vector representing a second transaction, the third feature vector being different than the fourth feature vector; generating a second sequence vector representing a second sequence of transactions associated with the second transaction, the second sequence of transactions including the second transaction and at least one transaction preceding the second transaction; providing the third feature vector as input into the first machine learning model, resulting in a third feature output value; providing the fourth feature vector as input into the second machine learning model, resulting in a fourth feature output value; providing the second sequence vector as input into the events sequence model, resulting in a second sequence output value; providing, a second cumulative input into the secondary machine learning model, resulting in a second cumulative probability value indicating a likelihood that the second transaction is fraudulent, wherein the second cumulative input is generated based on the third feature output value, the fourth feature output value, and the second sequence output value; and determining whether the second transaction is fraudulent based on a comparison of the second cumulative probability value to a second threshold probability value.

In Example 4, the subject matter of Examples 1-3 includes, wherein the first threshold probability value is different than the second threshold probability value.

In Example 5, the subject matter of Examples 1-4 includes, wherein the first threshold probability value is determined based on transaction data associated with a first account used to initiate the first transaction and the second threshold probability value is determined based on transaction data associated with a second account used to initiate the second transaction.

In Example 6, the subject matter of Examples 1-5 includes, wherein determining whether the first transaction is fraudulent based on a comparison of the first cumulative probability value to the first threshold probability value comprises: in response to determining, based on the comparison, that the first cumulative probability value is greater than the first threshold probability value, determining that the first transaction is fraudulent.

In Example 7, the subject matter of Examples 1-6 includes, wherein determining whether the first transaction is fraudulent based on a comparison of the first cumulative probability value to the first threshold probability value comprises: in response to determining, based on the comparison, that the first cumulative probability value is less than the first threshold probability value, determining that the first transaction is not fraudulent.

In Example 8, the subject matter of Examples 1-7 includes, wherein the first cumulative input is a vector including at least the first feature output value, the second feature output value, and the first sequence output value.

In Example 9, the subject matter of Examples 1-8 includes, further comprising: receiving external feedback data identifying a new feature; and retraining the first machine learning model based on the new feature.

In Example 10, the subject matter of Examples 1-9 includes, wherein retraining the first machine learning model based on the new feature comprises: generating synthetic training data based on a set of features used by the first machine learning model and the new feature identified by the external feedback data; and retraining the first machine learning model based on the synthetic training data.

Example 11 is a system comprising: one or more computer processors; and one or more computer-readable mediums storing instructions that, when executed by the one or more computer processors, cause the system to perform operations comprising: generating at least a first feature vector and a second feature vector representing a first transaction, the first feature vector being different than the second feature vector; generating a first sequence vector representing a sequence of transactions associated with the first transaction, the sequence of transactions including the first transaction and at least one transaction preceding the first transaction; providing the first feature vector as input into a first machine learning model, resulting in a first feature output value; providing the second feature vector as input into a second machine learning model, resulting in a second feature output value, the second machine learning model being different than the first machine learning model; providing the first sequence vector as input into an events sequence model, resulting in a first sequence output value; providing, a first cumulative input into a secondary machine learning model, resulting in a first cumulative probability value indicating a likelihood that the first transaction is fraudulent, wherein the first cumulative input is generated based on the first feature output value, the second feature output value, and the first sequence output value; and determining whether the first transaction is fraudulent based on a comparison of the first cumulative probability value to a first threshold probability value.

In Example 12, the subject matter of Example 11 includes, the operations further comprising: providing a third feature vector representing the first transaction as input into a third machine learning model, resulting in a third feature output value, wherein the first cumulative input is further generated based on the third feature output value.

In Example 13, the subject matter of Examples 11-12 includes, the operations further comprising: generating at least a third feature vector and a fourth feature vector representing a second transaction, the third feature vector being different than the fourth feature vector; generating a second sequence vector representing a second sequence of transactions associated with the second transaction, the second sequence of transactions including the second transaction and at least one transaction preceding the second transaction; providing the third feature vector as input into the first machine learning model, resulting in a third feature output value; providing the fourth feature vector as input into the second machine learning model, resulting in a fourth feature output value; providing the second sequence vector as input into the events sequence model, resulting in a second sequence output value; providing, a second cumulative input into the secondary machine learning model, resulting in a second cumulative probability value indicating a likelihood that the second transaction is fraudulent, wherein the second cumulative input is generated based on the third feature output value, the fourth feature output value, and the second sequence output value; and determining whether the second transaction is fraudulent based on a comparison of the second cumulative probability value to a second threshold probability value.

In Example 14, the subject matter of Examples 11-3 includes, wherein the first threshold probability value is different than the second threshold probability value.

In Example 15, the subject matter of Examples 11-14 includes, wherein the first threshold probability value is determined based on transaction data associated with a first account used to initiate the first transaction and the second threshold probability value is determined based on transaction data associated with a second account used to initiate the second transaction.

In Example 16, the subject matter of Examples 11-15 includes, wherein determining whether the first transaction is fraudulent based on a comparison of the first cumulative probability value to the first threshold probability value comprises: in response to determining, based on the comparison, that the first cumulative probability value is greater than the first threshold probability value, determining that the first transaction is fraudulent.

In Example 17, the subject matter of Example 11-16 includes, wherein determining whether the first transaction is fraudulent based on a comparison of the first cumulative probability value to the first threshold probability value comprises: in response to determining, based on the comparison, that the first cumulative probability value is less than the first threshold probability value, determining that the first transaction is not fraudulent.

In Example 18, the subject matter of Examples 11-17 includes, wherein the first cumulative input is a vector including at least the first feature output value, the second feature output value, and the first sequence output value.

In Example 19, the subject matter of Examples 11-18 includes, the operations further comprising: receiving external feedback data identifying a new feature; generating synthetic training data based on a set of features used by the first machine learning model and the new feature identified by the external feedback data; and retraining the first machine learning model based on the synthetic training data.

Example 20 is a non-transitory computer-readable medium storing instructions that, when executed by one or more computer processors of one or more computing devices, cause the one or more computing devices to perform operations comprising: generating at least a first feature vector and a second feature vector representing a first transaction, the first feature vector being different than the second feature vector; generating a first sequence vector representing a sequence of transactions associated with the first transaction, the sequence of transactions including the first transaction and at least one transaction preceding the first transaction; providing the first feature vector as input into a first machine learning model, resulting in a first feature output value; providing the second feature vector as input into a second machine learning model, resulting in a second feature output value, the second machine learning model being different than the first machine learning model; providing the first sequence vector as input into an events sequence model, resulting in a first sequence output value; providing, a first cumulative input into a secondary machine learning model, resulting in a first cumulative probability value indicating a likelihood that the first transaction is fraudulent, wherein the first cumulative input is generated based on the first feature output value, the second feature output value, and the first sequence output value; and determining whether the first transaction is fraudulent based on a comparison of the first cumulative probability value to a first threshold probability value.

What is clamed is:

1. A method comprising:
generating at least a first feature vector and a second feature vector representing a first transaction, the first feature vector being different than the second feature vector;
generating a first sequence vector representing a sequence of transactions associated with the first transaction, the sequence of transactions including the first transaction and at least one transaction preceding the first transaction;
providing the first feature vector as input into a first machine learning model, resulting in a first feature output value;
providing the second feature vector as input into a second machine learning model, resulting in a second feature output value, the second machine learning model being different than the first machine learning model;
providing the first sequence vector as input into an events sequence model, resulting in a first sequence output value;
providing, a first cumulative input into a secondary machine learning model, resulting in a first cumulative probability value indicating a likelihood that the first transaction is fraudulent, wherein the first cumulative input is generated based on the first feature output value, the second feature output value, and the first sequence output value; and
determining whether the first transaction is fraudulent based on a comparison of the first cumulative probability value to a first threshold probability value.

2. The method of claim 1, further comprising:
providing a third feature vector representing the first transaction as input into a third machine learning model, resulting in a third feature output value, wherein the first cumulative input is further generated based on the third feature output value.

3. The method of claim 1, further comprising:
generating at least a third feature vector and a fourth feature vector representing a second transaction, the third feature vector being different than the fourth feature vector;
generating a second sequence vector representing a second sequence of transactions associated with the second transaction, the second sequence of transactions including the second transaction and at least one transaction preceding the second transaction;
providing the third feature vector as input into the first machine learning model, resulting in a third feature output value;
providing the fourth feature vector as input into the second machine learning model, resulting in a fourth feature output value;
providing the second sequence vector as input into the events sequence model, resulting in a second sequence output value;
providing, a second cumulative input into the secondary machine learning model, resulting in a second cumulative probability value indicating a likelihood that the second transaction is fraudulent, wherein the second cumulative input is generated based on the third feature output value, the fourth feature output value, and the second sequence output value; and
determining whether the second transaction is fraudulent based on a comparison of the second cumulative probability value to a second threshold probability value.

4. The method of claim 3, wherein the first threshold probability value is different than the second threshold probability value.

5. The method of claim 4, wherein the first threshold probability value is determined based on transaction data associated with a first account used to initiate the first transaction and the second threshold probability value is determined based on transaction data associated with a second account used to initiate the second transaction.

6. The method of claim 1, wherein determining whether the first transaction is fraudulent based on a comparison of the first cumulative probability value to the first threshold probability value comprises:
in response to determining, based on the comparison, that the first cumulative probability value is greater than the first threshold probability value, determining that the first transaction is fraudulent.

7. The method of claim 1, wherein determining whether the first transaction is fraudulent based on a comparison of the first cumulative probability value to the first threshold probability value comprises:
in response to determining, based on the comparison, that the first cumulative probability value is less than the first threshold probability value, determining that the first transaction is not fraudulent.

8. The method of claim 1, wherein the first cumulative input is a vector including at least the first feature output value, the second feature output value, and the first sequence output value.

9. The method of claim 1, further comprising:
receiving external feedback data identifying a new feature; and
retraining the first machine learning model based on the new feature.

10. The method of claim 9, wherein retraining the first machine learning model based on the new feature comprises:
generating synthetic training data based on a set of features used by the first machine learning model and the new feature identified by the external feedback data; and
retraining the first machine learning model based on the synthetic training data.

11. A system comprising:
one or more computer processors; and
one or more computer-readable mediums storing instructions that, when executed by the one or more computer processors, cause the system to perform operations comprising:
generating at least a first feature vector and a second feature vector representing a first transaction, the first feature vector being different than the second feature vector;
generating a first sequence vector representing a sequence of transactions associated with the first transaction, the sequence of transactions including the first transaction and at least one transaction preceding the first transaction;
providing the first feature vector as input into a first machine learning model, resulting in a first feature output value;
providing the second feature vector as input into a second machine learning model, resulting in a second feature output value, the second machine learning model being different than the first machine learning model;
providing the first sequence vector as input into an events sequence model, resulting in a first sequence output value;
providing, a first cumulative input into a secondary machine learning model, resulting in a first cumulative probability value indicating a likelihood that the first transaction is fraudulent, wherein the first cumulative input is generated based on the first feature output value, the second feature output value, and the first sequence output value; and
determining whether the first transaction is fraudulent based on a comparison of the first cumulative probability value to a first threshold probability value.

12. The system of claim 11, the operations further comprising:
providing a third feature vector representing the first transaction as input into a third machine learning model, resulting in a third feature output value, wherein the first cumulative input is further generated based on the third feature output value.

13. The system of claim 11, the operations further comprising:
generating at least a third feature vector and a fourth feature vector representing a second transaction, the third feature vector being different than the fourth feature vector;
generating a second sequence vector representing a second sequence of transactions associated with the second transaction, the second sequence of transactions including the second transaction and at least one transaction preceding the second transaction;
providing the third feature vector as input into the first machine learning model, resulting in a third feature output value;
providing the fourth feature vector as input into the second machine learning model, resulting in a fourth feature output value;
providing the second sequence vector as input into the events sequence model, resulting in a second sequence output value;
providing, a second cumulative input into the secondary machine learning model, resulting in a second cumulative probability value indicating a likelihood that the second transaction is fraudulent, wherein the second cumulative input is generated based on the third feature output value; the fourth feature output value, and the second sequence output value; and
determining whether the second transaction is fraudulent based on a comparison of the second cumulative probability value to a second threshold probability value.

14. The system of claim 13, wherein the first threshold probability value is different than the second threshold probability value.

15. The system of claim 14, wherein the first threshold probability value is determined based on transaction data associated with a first account used to initiate the first transaction and the second threshold probability value is determined based on transaction data associated with a second account used to initiate the second transaction.

16. The system of claim 11, wherein determining whether the first transaction is fraudulent based on a comparison of the first cumulative probability value to the first threshold probability value comprises:
in response to determining, based on the comparison, that the first cumulative probability value is greater than the first threshold probability value, determining that the first transaction is fraudulent.

17. The system of claim 11, wherein determining whether the first transaction is fraudulent based on a comparison of the first cumulative probability value to the first threshold probability value comprises:
in response to determining, based on the comparison, that the first cumulative probability value is less than the first threshold probability value, determining that the first transaction is not fraudulent.

18. The system of claim 11, wherein the first cumulative input is a vector including at least the first feature output value, the second feature output value, and the first sequence output value.

19. The system of claim 11, the operations further comprising:
receiving external feedback data identifying a new feature;
generating synthetic training data based on a set of features used by the first machine learning model and the new feature identified by the external feedback data; and
retraining the first machine learning model based on the synthetic training data.

20. A non-transitory computer-readable medium storing instructions that, when executed by one or more computer processors of one or more computing devices, cause the one or more computing devices to perform operations comprising:
generating at least a first feature vector and a second feature vector representing a first transaction, the first feature vector being different than the second feature vector;
generating a first sequence vector representing a sequence of transactions associated with the first transaction, the sequence of transactions including the first transaction and at least one transaction preceding the first transaction;
providing the first feature vector as input into a first machine learning model, resulting in a first feature output value;
providing the second feature vector as input into a second machine model, resulting in a second feature output value, the second machine learning model being different than the first machine learning model;
providing the first sequence vector as input into an events sequence model, resulting in a first sequence output value;
providing, a first cumulative input into a secondary machine learning model, resulting in a first cumulative probability value indicating a likelihood that the first transaction is fraudulent, wherein the first cumulative input is generated based on the first feature output value, the second feature output value, and the first sequence output value; and
determining whether the first transaction is fraudulent based on a comparison of the first cumulative probability value to a first threshold probability value.
